(19) United States
(12) Patent Application Publication
(10) Pub. No.: US 2018/0192325 A1
(43) Pub. Date: Jul. 5, 2018

(54) DYNAMIC MOBILE NETWORK ARCHITECTURE

(71) Applicant: TELEFONAKTIEBOLAGET LM ERICSSON (PUBL), Stockholm (SE)

(72) Inventors: Fredrik SONNEVI, Hägersten (SE); Bengt PERSSON, Stockholm (SE); Stefan WAHLMAN, Kista (SE)

(21) Appl. No.: 15/741,156

(22) PCT Filed: Jun. 30, 2015
(86) PCT No.: PCT/SE2015/050763

§ 371 Date: Dec. 29, 2017

(51) Int. Cl. H04W 28/08; H04W 76/14; H04W 36/10

(52) U.S. Cl. CPC H04W 28/08; H04W 76/15; H04W 36/10; H04W 76/14

(57) ABSTRACT

A method of operating a wireless communication network including a central radio network controller C-RNC that is configured to control operation of a plurality of base stations and a distributed radio network controller D-RNC that is configured to control operation of at least one base station of the plurality of base stations is provided. The method includes selectively allocating radio network control functionality in the C-RNC or the D-RNC on a per radio access bearer basis. The radio network control functionality may be selectively allocated in the C-RNC or the D-RNC based on a detected condition of the wireless communication network.

### TECHNICAL FIELD

The present invention relates to communications networks. More particularly, and not by way of limitation, the present invention is directed to communications systems and methods that include radio network controllers and base stations.

### BACKGROUND

Wideband Code Division Multiple Access (WCDMA) is a mobile radio access network standard specified by a 3rd Generation Partnership Project (3GPP) and used in third generation wireless data/tele-communication systems.

An example third generation communications system 100 is shown in FIG. 1. The system 100 includes a plurality of user equipment nodes (UEs) 50 that communicate with a radio base station (RBS) 40 through a radio air interface 42. The RBS 40 is controlled by a radio network controller (RNC) 30 that is connected to a core network 20. In WCDMA parlance, the RBS is sometimes referred to as a NodeB. References herein to a NodeB shall be construed as applying to any base station unless otherwise mentioned.

In WCDMA, the RBS 40 is responsible for physical layer processing, such as error-correcting coding, modulation and spreading, as well as for converting signals from baseband to radio-frequency for transmission. A RBS 40 typically handles transmission and reception in one or more cells. A UE 50 may communicate with one or more RBS's 40, which enables the UE 50 to maintain a connection, for example with the core network, as it moves from cell to cell.

An RNC 30 controls multiple RBS's 40. The RNC 30 manages call setup, quality-of-service handling, and management of the radio resources in the cells for which it is responsible. The RNCs 30 and RBS's 40 collectively form a radio access network (RAN) 35 that enables a mobile UE 50 to access the core network.

WCDMA defines a number of communication interfaces through which various nodes of the system 100 communicate. For example, each RNC 30 connects to elements of the core network via the Iu interface. Each RNC 30 in the RAN 35 100 can connect to every other RNC 30 in the same RAN 35 using the Iur interface. The Iur interface is a network wide interface that enables RNCs 30 in the RAN 35 to communicate and cooperate with one another to support functions, such as mobility and macro diversity. Macro diversity refers to the ability of a UE 50 to communicate with multiple RBS's simultaneously. This enables soft handover of a connection with a UE 50 from one RBS 40 to another without having to establish a new connection to the UE 50. The Iur interface thus allows the RAN 35 to hide mobility functions from the core network 20.

An RNC 30 connects to one or more RBS's 40 using the Iub interface. However, in a conventional architecture, one RBS 40 can only connect to one RNC 30, and that RNC 30 controls the radio resources of the RBS 40. In the event of a handover across RNCs 30, the two RNCs 30 negotiate the use of radio resources over the Iur interface to effect the handover.

WCDMA uses a layered model for managing data communications between nodes. In a layered system, each layer is responsible for a specific part of the radio-access functionality. The protocol layers used in WCDMA are illustrated in FIG. 2.

Starting from the top, user plane data from the core network 20, which may be in the form of IP packets, are first processed by Layer 3 functionality. In WCDMA, this is implemented for user plane data by Packet Data Convergence Protocol (PDCP). Header compression may be performed in Layer 3 to save radio-interface resources.

Control plane data is processed in Layer 3 using Radio Resource Control (RRC) protocol, which communicates with the next layer (Layer 2) over various signaling channels.

From Layer 3, packets are passed to Layer 2 over radio access bearers (RABs), which are assigned to individual UEs. That is, each RAB is mapped to a single UE, and more than one RAB may be mapped to each UE. Layer 2 is implemented using the Radio Link Control (RLC) protocol. RLC is responsible for segmentation of the IP packets into smaller units known as RLC Protocol Data Units (RLC PDUs). At the receiving end, the RLC performs the corresponding reassembly of the received segments into IP packets.

The RLC protocol can request retransmissions of erroneous RLC PDUs. The need for a retransmission is indicated by the RLC entity at the receiving end to its peer RLC entity at the transmitting end by means of status reports.

The Medium Access Control (MAC) layer (Layer 1) provides logical channels to Layer 2 over which the RLC protocol can transmit RLC PDUs. The MAC layer multiplexes data from multiple logical channels and passes the data on to the physical layer. The MAC layer is responsible for determining the transport format of the data sent to the physical layer.

In a conventional WCDMA architecture, the RNC 30 controls the functionality of Layers 1-3, while the RBS controls the physical layer. That is, the RBS 40 essentially functions as a modem. The PDCP, RLC and MAC protocols may all be terminated in the RNC 30.

As described above, the RBS 40 controls the hardware of its cells, but not the radio resources, which are controlled by the RNC 30 that owns the RBS 40. Thus, the RBS can reject a connection due to hardware limitations, but not due to radio resource shortage.

As can be seen in FIG. 1, WCDM A is based on a hierarchical structure in which the RNC's control operation of the RBS's, and the RBS's communicate with the UEs.

This “classical” WCDMA architecture has a number of benefits, such as the ability to support soft handover, soft combining, simplified network management, etc. However, the classical architecture shown in FIG. 1 may also have some drawbacks, such as high bandwidth utilization, RAB setup latency, and low peak throughput for some deployment cases.

A so-called “flat” WCDMA architecture is described in 3GPP TS 25.413. In a flat architecture, functions of the RNC are distributed down to the RBS's. That is, each RBS essentially acts as its own RNC. In a flat architecture, each RBS terminates the Layer 1-3 protocols and the Iu interface. The flat architecture defined by 3GPP addresses the drawbacks in the classical architecture but introduces new short comings. For instance, flat architecture does not support soft handover or soft combining, network management is more troublesome, and there increased handover complexity which might lead to degraded performance (such as handover success rate).

Mobile infrastructure vendors are constantly working on improving their products to support higher down load bitrates, faster time to content to a lower operating expenditure (OPEX). However the flexibility to improve the system characteristics and modify the mobile network architecture may be limited by the 3GPP standards to secure interoperability between different network vendors and UE manufacturers.

### SUMMARY

Various embodiments of the present invention are directed to controlling the logical architecture of a wireless communications system.

In one embodiment, a method of operating a wireless communication network including a central radio network controller C-RNC (120) that is configured to control operation of a plurality of base stations and a distributed radio network controller D-RNC (130) that is configured to control operation of at least one base station of the plurality of base stations is provided. The method includes selectively allocating radio network control functionality in the C-RNC or the D-RNC on a per radio access bearer basis (202).

Further embodiments provide a method of operating a wireless communication network including at least one network controller (120) that controls operation of a plurality of base stations (40), and at least one of the plurality of base station (40). The method includes selectively allocating radio network control functionality between the network controller and the at least one base station in either a hierarchical structure or a flat structure on a per connection basis (204).

A radio network controller that is configured to control operation of a plurality of base stations, includes a network condition module (440) configured to detect a condition of a wireless communication network, a logical architecture computation module (420) configured to compute a logical architecture in response to the detected condition, and a functionality allocating module (430) configured to allocate network control functionality between the radio network controller and a distributed radio network controller (D-RNC) that is configured to control operation of at least one base station of the plurality of base stations, on a per radio access bearer basis.

Other network nodes, UEs, and/or methods according to embodiments of the invention will be or become apparent to one with skill in the art upon review of the following drawings and detailed description. It is intended that all such additional network nodes, UEs, and/or methods be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a block diagram of a conventional hierarchical system architecture for a wireless communication system.

FIG. 2 illustrates some aspects of the layered communication model used by wireless communication systems.

FIG. 3 is a block diagram of a wireless communication system architecture according to some embodiments.

FIG. 4 illustrates some aspects of the layered communication model that may be used by a wireless communication system according to some embodiments.

FIG. 5 is a block diagram that illustrates an example of a wireless communication system architecture according to some embodiments.

FIG. 6 is a block diagram that illustrates the protocol stacks of the example of a wireless communication system architecture shown in FIG. 5.

FIGS. 7-12 are flowcharts that illustrate operation of systems/methods according to some embodiments.

FIGS. 13 and 14 are block diagrams that illustrates a radio network controller that is configured according to some embodiments.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

As explained above, various embodiments of the present invention are directed to controlling the logical architecture of a wireless communications system.

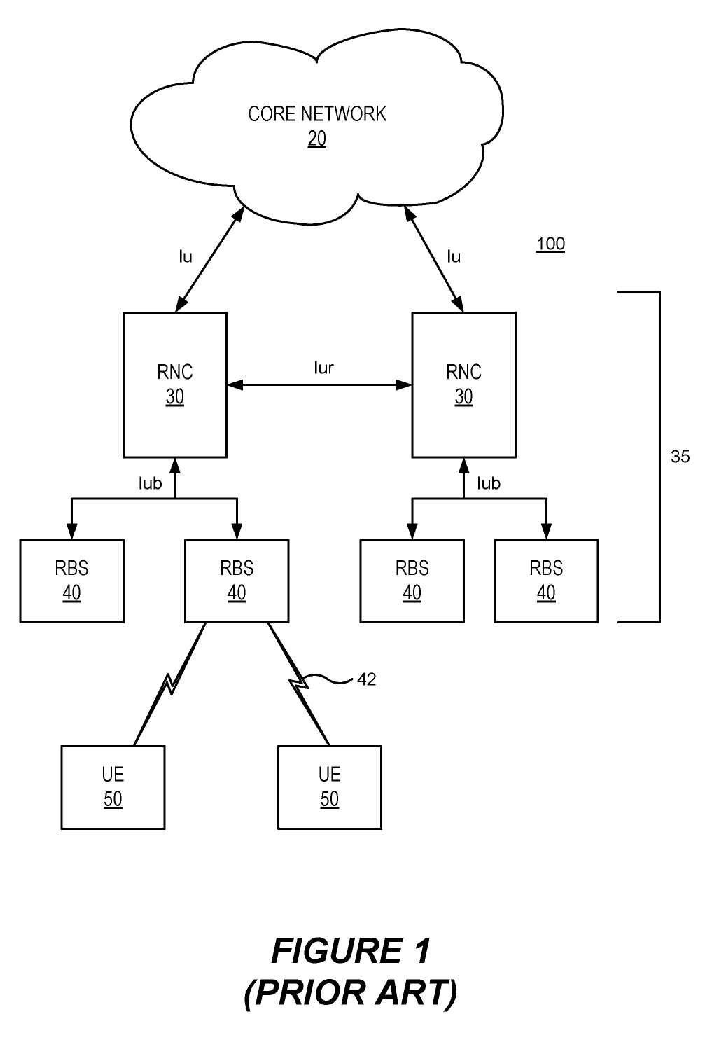

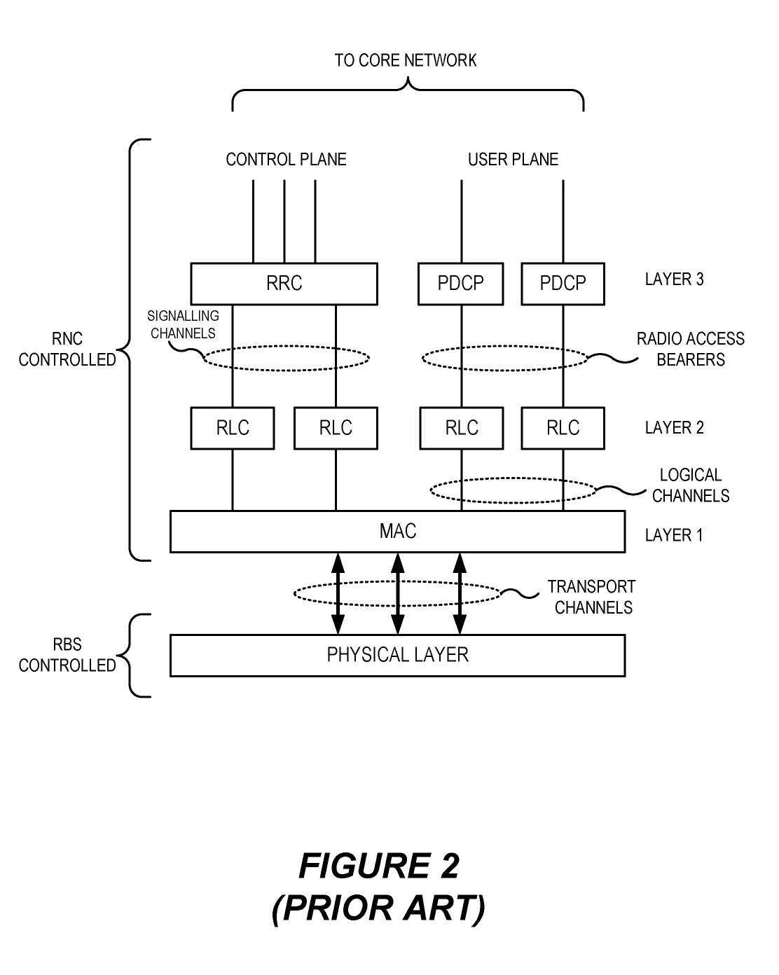

Some embodiments are disclosed in the context of a WCDMA 3GPP third generation communication system, such as the system 100 of FIG. 1, for ease of illustration and explanation only. However, the invention is not limited thereto as it may be embodied in other types of network nodes, UEs, and communication systems, including, but not limited to, 3GPP Long Term Evolution (LTE) systems.

The existing WCDMA architectures (flat and classical) may not be sufficiently flexible to obtain optimal performance in all deployment cases. For instance, in some markets the radio base station (RBS) backhaul capacity is limited, in that it may have long delays and/or be of poor quality. As a consequence, the end user experience may be degraded. For example, users may experience low peak data rates, long times to access content, etc.

The systems/methods described herein may enable wireless communication networks to obtain the benefits of both the classical and flat architectures. In particular, some embodiments of the inventive subject matter enable an RNC in a RAN to dynamically select a classical, flat or partially flat architecture (as described below) for a given connection based on one or more selection criteria.

The selection criteria may include, for example, information about the connection, such as RAB type, ARP, THP, and/or SI. The selection criteria may further include configuration information, such as a database table, and/or calculated information, such as admission control information. In addition, the selection criteria may further include measured or reported information about the status of elements of the RAN, such as round trip time, processor load and/or throughput. It will be appreciated that the foregoing is not an exhaustive list of information that can be used as selection criteria, and that other factors may be utilized to determine what logical architecture (classical, flat or partially flat) to choose for a given connection.

In some embodiments, a logical architecture may be selected for each RAB in a cell. This may enable each connection to be optimized per user and base station.

Some embodiments of the inventive concepts, which may be referred to as dynamic mobile network architecture selection, may provide benefits, such as increasing end user bitrates and improving time to content (access times), while providing support for soft handover and soft combining. Some embodiments may provide additional benefits, such as lower operational expenses, simplified RAN management, etc.

According to some embodiments, a Central-RNC (C-RNC) and a Distributed-RNC (D-RNC) are defined. A C-RNC and a D-RNC may cooperatively implement the functions of an RNC, but may be located at different physical locations. For example, a C-RNC may be physically located at a regional switch site that connects thousands of NodeBs, while a D-RNC may be physically located closer to, or even co-located with, an RBS. A D-RNC may be connected to only one or to several RBS's.

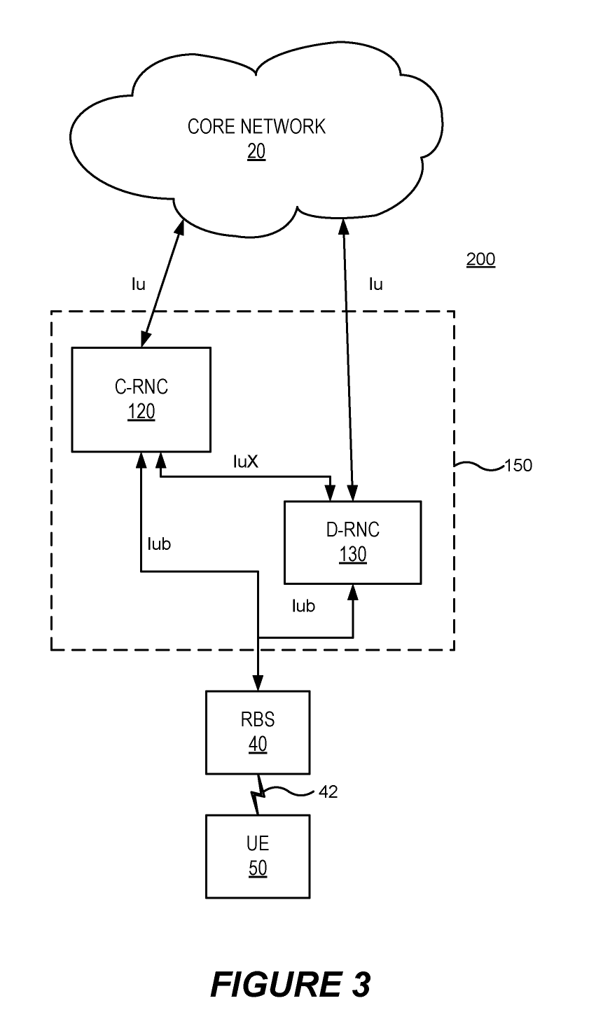

An example communications system 200 that is configured according to some embodiments is shown in FIG. 3. As in a conventional system shown in FIG. 1, the system 200 includes a plurality of user equipment nodes (UEs) 50 that communicate with a radio base station (RBS) 40 through a radio air interface 42. In the system 200, the RBS 40 is controlled by a radio network controller (RNC) 150 that is connected to a core network 20, however, the functionality of the RNC 150 is split between a C-RNC 120 and a D-RNC 130 that communicate over a novel interface, denoted in FIG. 3 as the IuX interface. The IuX interface is used by the C-RNC 120 and the D-RNC 130 to coordinate the allocation of various RNC functions as described in more detail below. Both the C-RNC 120 and the D-RNC 130 may communicate with the same RBS 40 using the Iub interface and with the core network 20 using the Iu interface.

Note that the D-RNC 120 can connect directly to the core network 20 only in the user plane, while the control plane connection is through the C-RNC 120.

From an external point of view, the C-RNC and D-RNC looks and behaves in accordance to the existing 3GPP standards.

In general, as between a C-RNC 120 and an associated D-RNC 130, the C-RNC is responsible for architecture selection. That is, the C-RNC determines, for each connection established by an RBS under its control, where the Layer 2 and Layer 3 functionality for th connection is to be located, and where the physical Iub, Iur, Iu_PS and Iu_CS terminations are to be located. For example, the C-RNC can determine where Layer 2 functionality, such as frame protocol (FP), medium access control (MAC), radio link control (RLC), and/or packet data convergence protocol (PDCP) processing functions can be located, and where layer 3 functionality, such as radio resource control (RRC) and RBS signaling (C/D-NBAP) functions are located. The C-RNC can cause some or all of these functions to be performed in the C-RNC or the D-RNC.

For a given C-RNC and D-RNC, multiple connections may be established having different logical architectures. For example, for a first connection for which a first RAB is established, the Layer 2, or L2, and Layer 3, or L3, functionality may be performed by the C-RNC, while for a first connection for which a first RAB is established, the L3 functionality may be performed by the C-RNC but the L2 functionality may be handled by the D-RNC.

As noted above, the D-RNC can be physically located much closer to an RBS, and in some cases co-located with the RBS. In some cases, the C-RNC may be located at a central switch site that serves hundreds or thousands of RBS's, while the D-RNC may be located at a hub site that serves a subset of the RBS's served by the central switch site.

A C-RNC supports all the 3GPP defined functions and external interfaces; however, a D-RNC may only supports a subset of the 3GPP defined functions and external interfaces. For example, a D-RNC

According to some embodiments, the user plane, UE control plane (RRC) and RBS control plane (e.g., the NodeB Application Part, or NBAP) can be terminated and handled by different D/C-RNC's. For example, the data/control traffic can be routed different physical paths to different terminating D/C-RNC's.

The C-RNC may terminate the SS7 protocol, which provides signaling control for circuit-switched connections.

When an RAB is requested, the C-RNC selects a logical architecture for the RAB based on information received, calculated, configured or measured. For example, the decision to locate L2 or L3 functionality in the D-RNC or the C-RNC may be based on a number of factors, including the quality of the link between the C-RNC and the RBS, the quality of the link between the D-RNC and the RBS, the processor load in the C-RNC and the D-RNC, the buffer state (e.g. buffer fullness) in the C-RNC and the D-RNC, or other factors.

In general, the C-RNC decides where to locate the L2 and L3 functions and the related physical interfaces (Iub, Iu_PS, Iu_CS, Iur) in order to gain some performance benefit, e.g. to increase throughput, reduce latency and response times, optimize resource allocation, etc.

For so-called multi-RAB situations in which multiple RABs are combined, if the logical architecture has been decided for a first RAB, then when a second RAB is added, the RNC may have three options for how to handle the added RAB. First, the RNC could simply ignore the suboptimal allocation and establish the new RAB with the same logical architecture as the first RAB. Second, the RNC could release the first RAB and reestablish it with a new logical architecture. Finally, the RNC could move the location of the L2 termination for the first RAB to match the new optimal allocation. Which logical architecture to select could depend on, for example, the specific RAB combinations, where the L2 termination initially was located, the transport characteristics and functionality implemented in the system.

Since the C-RNC/D-RNC combination appears externally as a single RNC 150, macro diversity can still be supported between RNC sites, provided that transport delays can be tolerated.

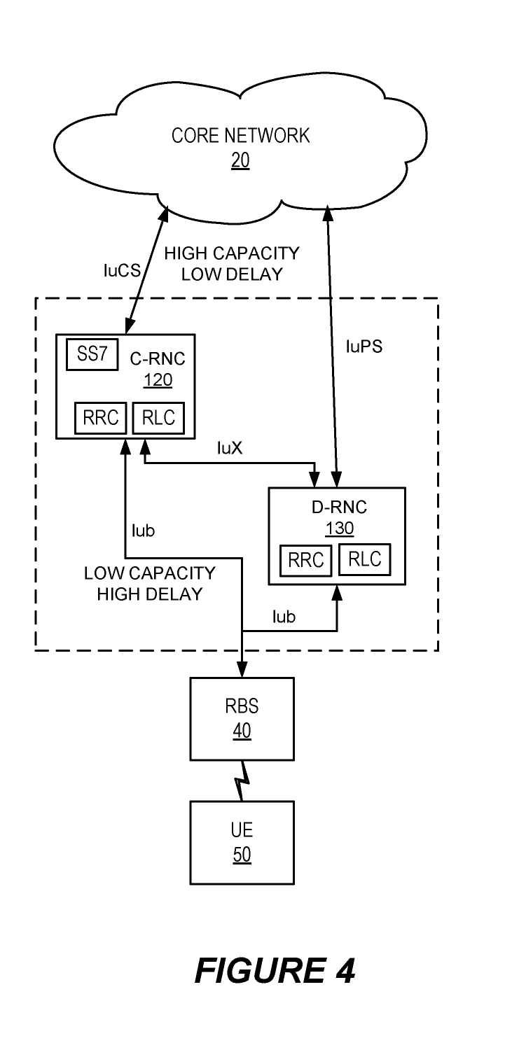

An example of a C-RNC/D-RNC allocation is illustrated in FIG. 4. In the example, a conversational (voice) RAB establishment request is received in C-RNC 120 from the core network 20. The C-RNC 120 decides to locate the L2/L3 (RLC/RRC) termination for the RAB in the C-RNC 120 in order to be able to use the soft handover functionality. The SS7 interface also terminates in the C-RNC 120. The benefit in this case is extended cell coverage, proven handover characteristics and shortest possible delay.

Next, an interactive (data) RAB establishment request is received in C-RNC 120 from the core network 20. In this case, the C-RNC 120 measures the transport characteristics of the connection between the C-RNC 120 and the RBS 40 and determines that the connection has a long delay. In this case, the C-RNC 120 decides to locate the L2/L3 termination in the D-RNC 130 in order to obtain high peak data throughput and short time to content. Additionally the C-RNC 120 may decide that the Iu_PS user plane will connect to the core network from the D-RNC 130. The selected logical configuration is communicated to the D-RNC over the IuX interface.

FIG. 5 illustrates the protocol stacks for the example logical architecture allocations illustrated in FIG. 4 for a WCDMA implementation. In the example illustrated in FIG. 5, the RBS is a NodeB. The D-RNC is located at a hub site, while the C-RNC is located a switch site. The core network includes a gateway GPRS support node (GGSN) 160 that communicates with the C-RNC 120.

As illustrated in FIG. 5, both the C-RNC 120 and the D-RNC 130 terminate RRC signaling connections with the UE 50. For the packet switched connection (PS RAB), the PDCP, RLC and MAC protocol terminations with the UE 50 are provided by the D-RNC 130, which communicates with the C-RNC 120 using the IuX protocol that utilizes UDP/IP communication services. Note that the RBS site provides a second MAC interface with the UE to coordinate the MAC connections between the C-RNC and the UE and the D-RNC and the UE. As will be appreciated, the MAC layer may include several sub-layers. Different sub-layers may be used depending on the type of RAB that is set up. The upper MAC layer is referred to as the MAC-d layer, while the lower MAC layers are referred to as the MAC-hs/ehs or MAC-e/i layers.

In this example, for both the packet switched connection and the circuit switched connection, the C-RNC terminates the Iu protocol with the GGSN 160.

For the circuit switched connection (CS RAB), the PDCP, RLC and MAC protocol terminations with the UE 50 are provided by the C-RNC 120. In this case, the D-RNC 130 may only provide a UDP/IP connection to the RBS 40.

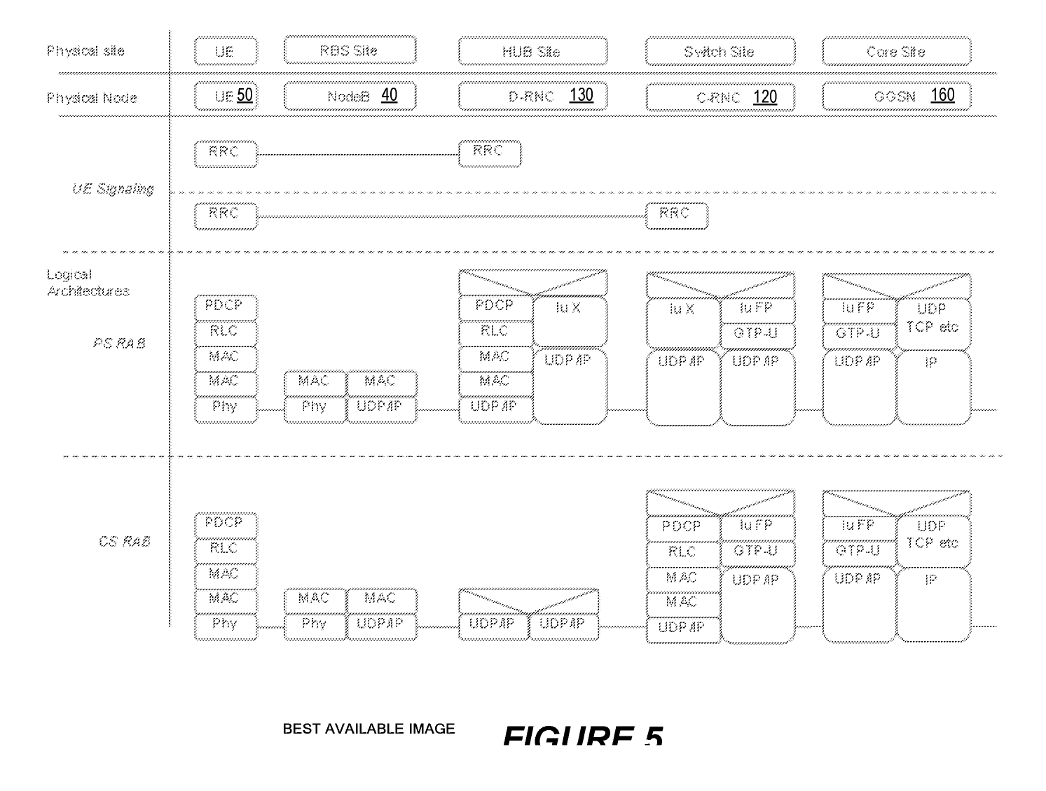

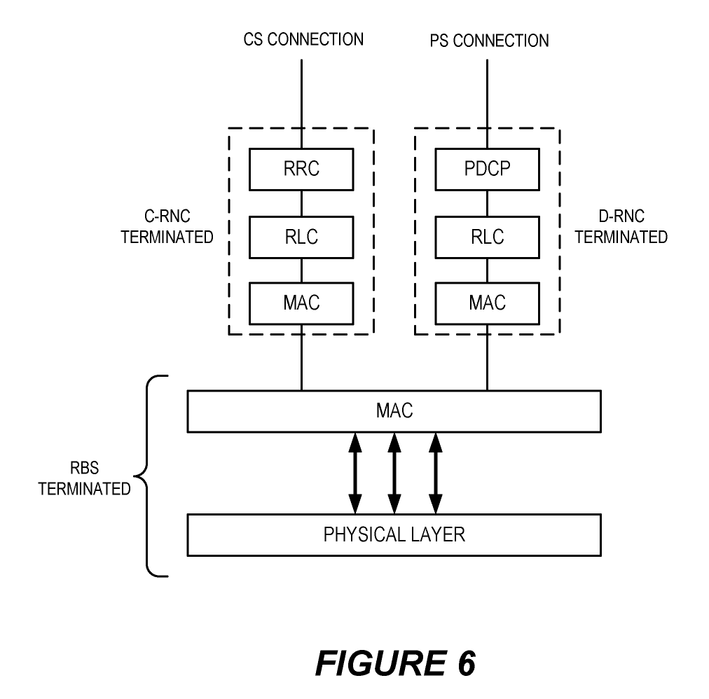

FIG. 6 illustrates the packet switched and circuit switched connections in the foregoing example in layer form. As shown in FIG. 6, in the circuit switched connection, the RRC, RLC and MAC layers are terminated in the C-RNC 120, while in the packet switched connection, the RRC, RLC and MAC layers are terminated in the D-RNC 130. The RBS terminates the lower MAC layer and the physical layer connection with the UE 50.

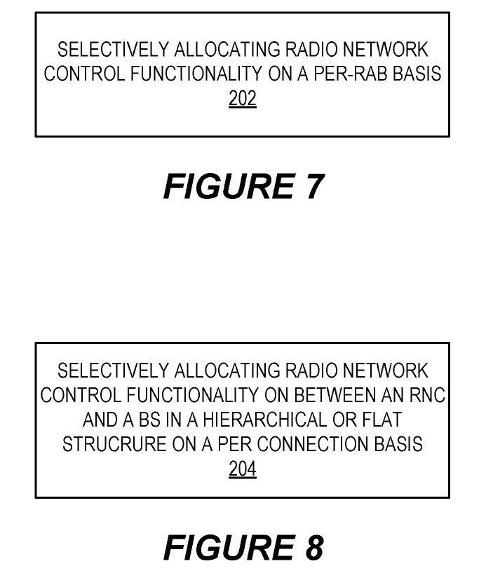

FIGS. 7-12 illustrate operations of systems/methods according to various embodiments. Referring to FIGS. 3 and 7, a method of operating a wireless communication network 200 including a central radio network controller C-RNC (120) that is configured to control operation of a plurality of base stations and a distributed radio network controller D-RNC (130) that is configured to control operation of at least one base station of the plurality of base stations includes selectively allocating radio network control functionality in the C-RNC or the D-RNC on a per radio access bearer basis (block 202). That is, for each connection to a UE, the C-RNC 120 determines whether the L2, L3 and related physical terminations should reside in the C-RNC or in a D-RNC that is remote from the C-RNC. The physical interface terminations may include Iub, Iur, Iu_PS and/or Iu_CS terminations. The decision of where to locate the various functions may be based on selection criteria that take into account, for example, network status, link quality, processor load or other criteria.

FIG. 8 illustrates a method of operating a wireless communication network according to further embodiments. The network includes at least one network controller (120) that controls operation of a plurality of base stations (40), and at least one of the plurality of base station (40), and the method includes selectively allocating radio network control functionality between the network controller and the at least one base station in either a hierarchical structure or a flat structure on a per connection basis (block 204).

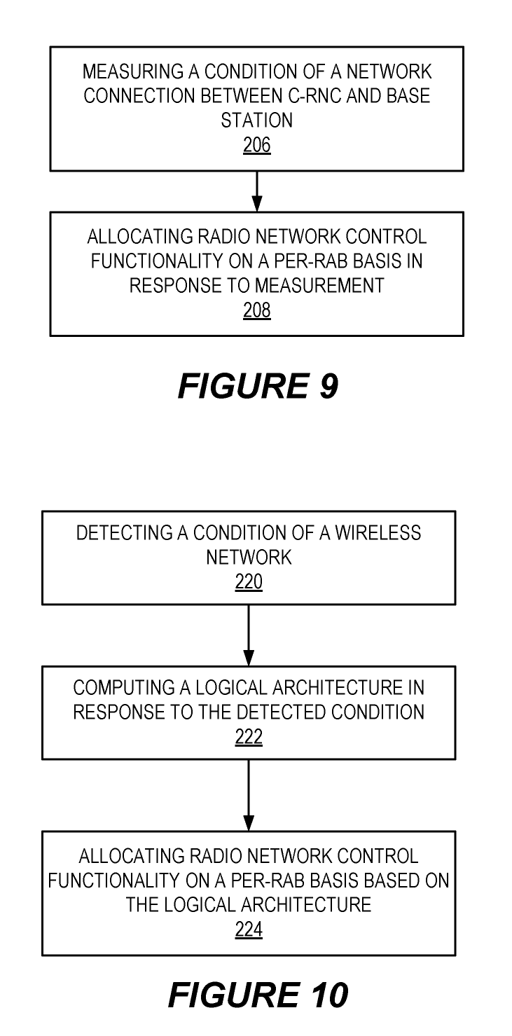

Referring to FIG. 9, the methods may further include measuring a condition of a network connection between the C-RNC and the at least one base station (block 206). The C-RNC may selectively allocate the radio network functionality in either the C-RNC or the D-RNC in response the measured network condition (block 208). In some embodiments, the measurement may be performed by the D-RNC. However, the network conditions relied on by the C-RNC to determine the desired network architecture may be measured and reported to the C-RNC by another node in the network, including for example, the D-RNC, an RBS, a UE.

The radio network control functionality that is allocated by the C-RNC may include L2 functionality, L3 functionality, radio base station (RBS) control functionality and/or user data plane functionality. The radio network control functionality may further include frame protocol, media access control, radio link control, and or packet data convergence protocol functionality. Still further, the radio network control functionality that is allocated by the C-RNC may include user plane control functionality, radio resource control functionality and/or radio base station control functionality.

Referring to FIG. 10, the methods may further include detecting a condition of the C-RNC and/or the D-RNC (block 220) and computing a desired logical architecture in response to the detected condition (block 222). The radio network control functionality is then selectively allocated in either the C-RNC or the D-RNC in response the detected condition of the C-RNC and/or the D-RNC (block 224). The detected condition of the C-RNC and/or the D-RNC may include a processor load and/or a buffer status of the C-RNC and/or the D-RNC.

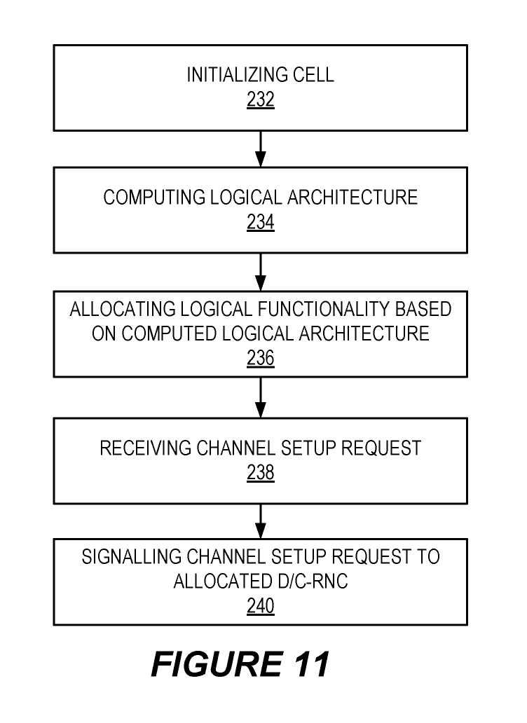

FIG. 11 illustrates systems/methods according to some embodiments for establishing a logical architecture in when a cell is initialized. When a cell is initialized by an RBS (block 232), the C-RNC that is responsible for the cell computes a desired logical architecture for the overall cell (block 234). The logical architecture may be computed based on received, calculated or stored information. In some cases, the logical architecture may be computed based on a preconfigured plan that defines locations of the radio network control functionality for a plurality of radio access bearers.

The C-RNC then allocates logical functionality between the C-RNC and a D-RNC based on the computed logical architecture (block 236). In particular, the C-RNC may determine a logical location of the NBAP termination and/or cell control handling for the cell upon initialization. When a channel setup request is received by the C-RNC (block 238), the C-RNC signals the channel setup request to the allocated D-RNC or C-RNC based on the computed logical architecture over the IuX interface (block 240).

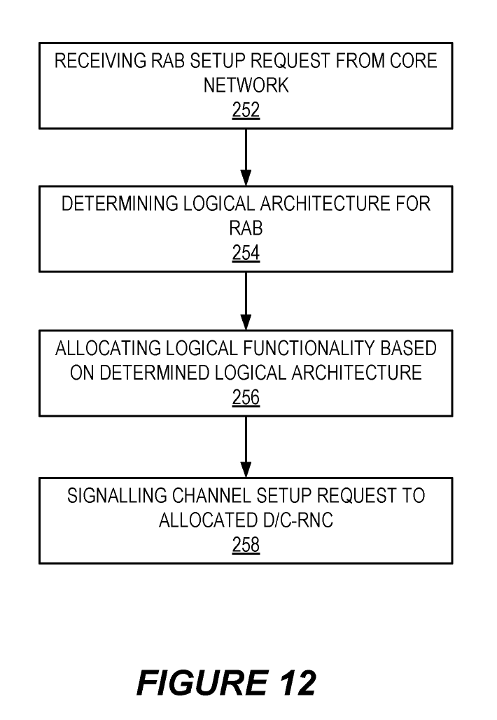

FIG. 12 illustrates systems/methods according to some embodiments for establishing a logical architecture for a connection in response to a RAB setup request. When a connection setup request (252) is received, the C-RNC may determine what type of connection is requested. For example, the C-RNC may determine whether the connection setup request specifies a circuit switched connection or a packet switched connection.

The C-RNC computes a desired logical architecture for the connection (block 254), and allocates logical functionality between the C-RNC and a D-RNC based on the computed logical architecture (block 256). In particular, the C-RNC may determine a logical location of the NBAP termination, the RRC termination, the PDCP termination, Iu_CS termination, Iu_PS termination and/or UE control handling for the connection. The C-RNC then signals the channel setup request to the allocated D-RNC or C-RNC based on the computed logical architecture over the IuX interface (block 258).

In some embodiments, user equipment control plane functionality may be allocated in one of the C-RNC and the D-RNC, and radio base station control plane functionality may be allocated in the other of the C-RNC and the D-RNC.

In some embodiments, user equipment control plane functionality may be allocated in one of the C-RNC and the D-RNC, and user plane functionality may be allocated in the other of the C-RNC and the D-RNC.

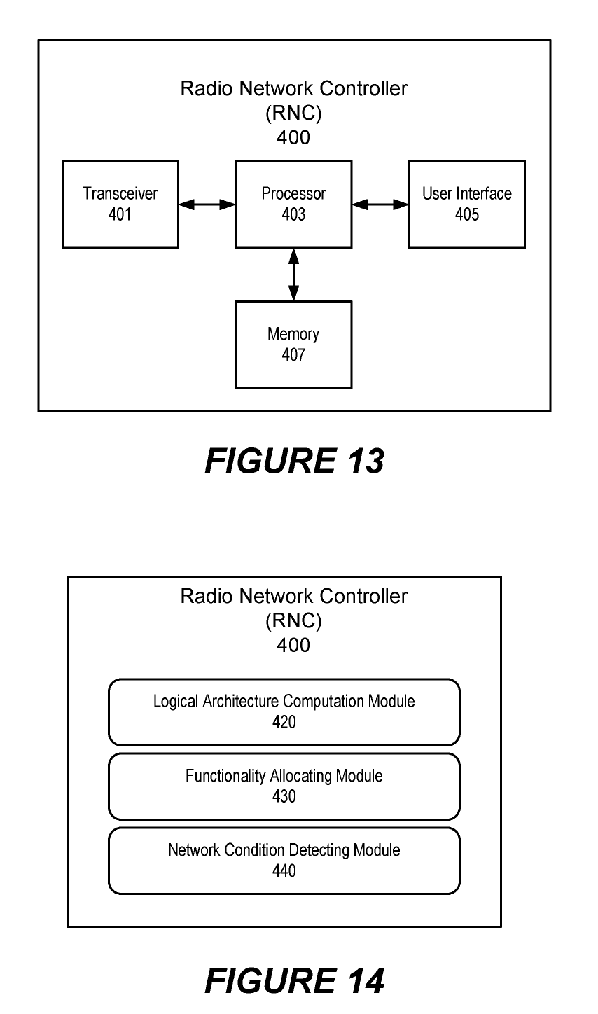

FIG. 13 is a block diagram that illustrates features of a radio network controller 400 according to some embodiments. The radio network controller 400 of FIG. 13 may be used to implement a C-RNC and/or a D-RNC as described above. The radio network controller 400 includes a processor 403, along with a transceiver 401, a user interface 405 and a memory 407 coupled to the processor 403. The memory 407 may include computer program instructions configured to cause the radio network controller to carry out the functions described herein.

For example, referring to FIG. 14, further aspects of a radio network controller 400 are illustrated. The radio network controller 400 includes a network condition module (440) configured to detect a condition of a wireless communication network, a logical architecture computation module (420) configured to compute a logical architecture in response to the detected condition, and a functionality allocating module (430) configured to allocate network control functionality between the radio network controller and a distributed radio network controller (D-RNC) that is configured to control operation of at least one base station of the plurality of base stations, on a per radio access bearer basis. The network condition module, the logical architecture computation module and the functionality allocating module may all be physically embodied in the memory 407 of the RNC 400.

### ABBREVIATIONS

ARP Allocation and Retention Priority
C-RNC Central RNC
D-RNC Distributed RNC
FP Frame Protocol
GSM Global System for Mobile Communications
GTP-U GRPS Tunneling Protocol-User Plane
HO Hand Over
HOSR HO Success Rate
KPI Key Performance Indicator
LTE Long Term Evolution
MAC Media Access Control
OPEX Operating Expenditures
QoS Quality of Service
PDCP Packet Data Convergence Protocol
Phy Physical (layer)
RAB Radio Access Bearer
RAN Radio Access Network
RBS Radio Base Station
RF Radio Frequency
RL Radio Link
RLC Radio Link Control
RNC Radio Network Controller
RRC Radio Resource Control
RTT Round Trip Time
UE User Equipment
WCDMA Wideband Code Division Multiple Access
WiFi Wireless LAN
UE User Equipment

### Further Definitions and Embodiments

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When a node is referred to as being “connected”, “coupled”, “responsive”, or variants thereof to another node, it can be directly connected, coupled, or responsive to the other node or intervening nodes may be present. In contrast, when an node is referred to as being “directly connected”, “directly coupled”, “directly responsive”, or variants thereof to another node, there are no intervening nodes present. Like numbers refer to like nodes throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, nodes, steps, components or functions but does not preclude the presence or addition of one or more other features, integers, nodes, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. A method of operating a wireless communication network including a central radio network controller C-RNC that is configured to control operation of a plurality of base stations and a distributed radio network controller D-RNC that is configured to control operation of at least one base station of the plurality of base stations, the method comprising:
selectively allocating radio network control functionality in the C-RNC or the D-RNC on a per radio access bearer basis.

2. The method of claim 1, further comprising:
measuring a condition of a network connection between the C-RNC and the at least one base station;
wherein selectively allocating the radio network control functionality comprises selectively allocating the radio network functionality in either the C-RNC or the D-RNC in response the measured network condition.

3. The method of claim 2, wherein the measurement is performed by the D-RNC.

4. The method of claim 1, wherein the radio network control functionality comprises frame protocol, media access control, radio link control, and or packet data convergence protocol functionality.

5. The method of claim 1, wherein the radio network control functionality comprises user plane control functionality, radio resource control functionality and/or radio base station control functionality.

6. The method of claim 1, further comprising:
detecting a condition of the C-RNC and/or the D-RNC;
wherein selectively allocating the radio network control functionality comprises selectively allocating the radio network control functionality in either the C-RNC or the D-RNC in response the detected condition of the C-RNC and/or the D-RNC.

7. The method of claim 6, wherein the condition of the C-RNC and/or the D-RNC comprises a processor load and/or a buffer status of the C-RNC and/or the D-RNC.

8. The method of claim 1, further comprising:
receiving a connection setup request, wherein selectively allocating the radio network control functionality is performed based on whether the connection setup request specifies a circuit switched connection or a packet switched connection.

9. The method of claim 1, wherein selectively allocating the radio network control functionality is performed in response to a preconfigured plan that defines locations of the radio network control functionality for a plurality of radio access bearers.

10. The method of claim 1, further comprising:
selectively allocating physical interface terminations in the C-RNC or the D-RNC on a per radio access bearer basis.

11. The method of claim 10, wherein the physical interface terminations comprise Iub, Iur, Iu_PS and/or Iu_CS terminations.

12. The method of claim 1, wherein the radio network control functionality comprises L2 functionality, and wherein the method further comprises: after allocating the L2 functionality, changing the L2 functionality allocation on a per radio access bearer basis based on a change in network conditions.

13. The method of claim 1, further comprising:
detecting a condition of a wireless communication network; and
computing a logical architecture in response to the detected condition;
wherein selectively allocating the radio network control functionality in the C-RNC or the D-RNC is performed based on the computed logical architecture.

14. The method of claim 1, further comprising receiving a radio access bearer setup request from a core network and determining a logical architecture for the radio access bearer, wherein selectively allocating the radio network control functionality is performed in response to the radio access bearer setup request.

15. The method of claim 1, wherein selectively allocating the radio network control functionality comprises locating user equipment control plane functionality in one of the C-RNC and the D-RNC, and locating radio base station control plane functionality in the other of the C-RNC and the D-RNC.

16. The method of claim 1, wherein selectively allocating the radio network control functionality comprises locating user equipment control plane functionality in one of the C-RNC and the D-RNC, and locating user plane functionality in the other of the C-RNC and the D-RNC.

17. The method of claim 1, wherein the C-RNC is located at a switch site, and the D-RNC is located at a hub site.

18. The method of claim 1, wherein the C-RNC is located at a switch site, and the D-RNC is located at a base station.

19. The method of claim 1, wherein the radio network control functionality comprises L2 functionality, L3 functionality, radio base station (RBS) control functionality and/or user data plane functionality.

20. A radio network controller that is configured to control operation of a plurality of base stations, comprising:
a processor; and
a memory coupled to the processor and including computer program instructions that, when executed by the processor, are configured to cause the radio network controller to:
detect a condition of a wireless communication network;
compute a logical architecture in response to the detected condition; and
allocate, based on the computed logical architecture, network control functionality between the radio network controller and a distributed radio network controller (D-RNC) that is configured to control operation of at least one base station of the plurality of base stations, on a per radio access bearer basis.

21. A method of operating a wireless communication network including at least one network controller that controls operation of a plurality of base stations, and at least one of the plurality of base station, comprising:
selectively allocating radio network control functionality between the network controller and the at least one base station in either a hierarchical structure or a flat structure on a per connection basis.
